(19) United States
(12) Patent Application Publication
(10) Pub. No.: US 2008/0001505 A1
(43) Pub. Date: Jan. 3, 2008

(54) MAIN ELEMENT FOR AN ELECTRICAL MACHINE

(76) Inventor: Michael Habele, Waldenbuch (DE)

Correspondence Address: Striker, Striker & Stenby, 103 East Neck Road, Huntington, NY, 11743, US

(21) Appl. No.: 11/677,822

(22) Filed: Feb. 22, 2007

(30) Foreign Application Priority Data
Jun. 28, 2006 (DE) 102006029628.1

(51) Int. Cl. H02K 1/18

(52) U.S. Cl. 310/67 R; 310/218

(57) ABSTRACT

A main element, in particular a stator, for an electrical machine, in particular for a universal motor, includes a flux return ring with at least two poles that are situated radially on the flux return ring, and each of which accommodates at least one coil, the poles can be connected with the flux return ring.

### CROSS-REFERENCE TO A RELATED APPLICATION

The invention described and claimed hereinbelow is also described in German Patent Application DE 102006029628.1 filed on Jun. 28, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a main element, particularly a stator, for an electrical machine, in particular for a universal motor.

Publication WO 92/10020 A makes known a stator for a two-pole electrical machine that is composed of a two-part lamina bundle to accommodate the stator winding. The stator is divided in the longitudinal direction, thereby forming two symmetrical lamina bundle parts, the parting plane of which extends through the middle of the two diametrically opposed legs of the magnetic flux return. To simplify manufacture and assembly, the two lamina bundle parts are held together along this parting plane via snap-in connections.

When the stator is assembled, the coils are first placed on the particular pole shoe of the two lamina bundle parts, then the two lamina bundle parts are connected with each other via snap-in connections. This type of assembly is relatively expensive, because a separate step is required to connect the two lamina bundle parts of the stator with each other. Also, when the coils are installed in this manner, the geometry of the coils is limited, since the coils must be wide enough that they can be guided around the pole horns when they are placed on the pole shoe.

### SUMMARY OF THE INVENTION

Accordingly, it is an object of the present invention to provide a main element for an electrical machine which avoids the disadvantages of the prior art.

In keeping with these objects and with others which will become apparent hereinafter, one feature of the present invention resides, briefly stated, in a main element for an electrical machine, comprising a flux return ring with at least two poles that are situated radially on said flux return ring, and at least one coil accommodated in each of said two poles, wherein said poles are connectable with said flux return ring.

With the inventive main element, the poles can be connected with the flux return ring, i.e., the poles are not designed integral with the flux return ring. The coils can therefore be placed on the pole shoe before the poles are connected with the flux return ring. The advantage of this is that the coils can be wound more tightly around the pole shoe. As a result, given the same electrical resistance, a greater number of windings and, therefore, a greater fullness factor is made possible than with a two-part stator as made known in WO 92/10020 A. When the coils are wound more tightly around the pole shoe, the coils are more securely retained on the pole shoes.

The poles are preferably detachably connectable with the flux return ring. This is advantageous in that a single coil can be replaced by removing the pole from the flux return ring, then placing a new coil on the flux return ring. To replace a coil on a stator according to WO 92/10020 A, the stator would first have to be separated into its two lamina bundle parts.

In particular, the poles are connectable with the flux return ring in a form-fit manner, a non-positive manner, or a bonded manner, or with a combination of these types of connections. The poles are preferably detachably connectable with the flux return ring using a screw connection. A screw connection can be realized, e.g., by providing the poles with boreholes with internal threads in the region of the pole shoe, in particular in the region of the surface of the pole shoe that faces the flux return ring. The flux return ring therefore includes openings that align with the boreholes in the pole shoes when the pole shoes rest on the flux return.

To attach the pole shoes, screws are passed through the openings in the flux return ring and into the thread of the boreholes in the pole shoes. In addition, or as an alternative thereto, a form-fit connection can be provided, e.g., by providing the flux return ring with a recess, e.g., in the form of an axial groove, into which a pole shoe engages. To obtain an adequate form-fit connection, the pole shoe can be shaped in a suitable manner. For example, the pole shoe can be shaped such that it forms a rear section in a recess in the flux return ring, e.g., an axial groove.

The inventive main element includes a flux return ring and at least two poles that are positioned radially over their pole shoes on the flux return ring, and they form a pole pair. In particular, the two poles of a pole pair are located diametrically relative to each other. Four poles or a higher, even number of poles are located equidistantly, in particular, along the flux return ring. Each of the poles accommodates at least one coil.

The flux return ring is composed of a bundle of lamina that are positioned next to each other axially, end to end (lamina bundle). The flux return ring is essentially cylindrical in shape, and the cross section of the flux return is, e.g., essentially round. The cross section can also have a different shape, e.g., the flux return ring can also have one or more flat areas. In particular, the flux return is designed as a one-piece component. Within the context of the present invention, a one-piece component flux return ring is understood to mean a flux return ring, the lamina of which are designed as one-piece components.

In contrast to the stator made known in WO 92/10020 A, the flux return ring is therefore not divided into two or more parts in the longitudinal direction (or in any other direction). With the inventive main element, there is therefore no separating air gap in the flux return ring, so the magnetic flux density of the flux return ring is greater and, therefore, the magnetic resistance is less. As a result, a universal motor with an inventive main element as the stator has a lower no-load speed at the same torque level and with the same amount of heating.

The poles are preferably designed as one-piece components, however, e.g., out of iron, sintered metal, or another soft-magnetic material. This has the advantage that they can be easily connected with the flux return ring. The poles, however, can be composed of a bundle of lamina that are positioned next to each other axially, end to end. To attach the poles to the flux return ring, the lamina of a pole are connected with each other in a suitable manner in the region of the pole shoe, particularly in the region of the surface of the pole shoe facing the flux return ring.

The coils can be attached to the pole shoes, e.g., by winding the coils directly onto the pole shoes. To this end, the poles are transported to the winding machine. Since the poles are not installed on the flux return ring when the coils are put in place, the windings of the coils can be wound more tightly around the pole shoes. As an alternative, the coils can be prefabricated as separate components and subsequently installed on the pole shoes by sliding them onto the pole shoes from their free end. The winding of the coils can also be tighter in this embodiment, since the coils can be slid onto the pole shoes directly. They do not have to be guided around the pole horns, as is required for the stator according to WO 92/10020 A.

The coils can be pretreated and/or post-treated in the manner known per se, e.g., they can be coated with a stove lacquer and/or they can be powder-coated.

When the inventive main element is assembled, the first step is to place the coils on the pole shoes of the poles. The poles are then placed on the flux return ring.

The inventive main element preferably relates to a stator of a universal motor with an inner-rotor design.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows an embodiment of the inventive main element in the assembled state, in a schematic depiction.

FIG. 2 shows the main element in FIG. 1, in an exploded view, in accordance with the present invention.

### DESCRIPTION OF THE PREFERRED EMBODIMENTS

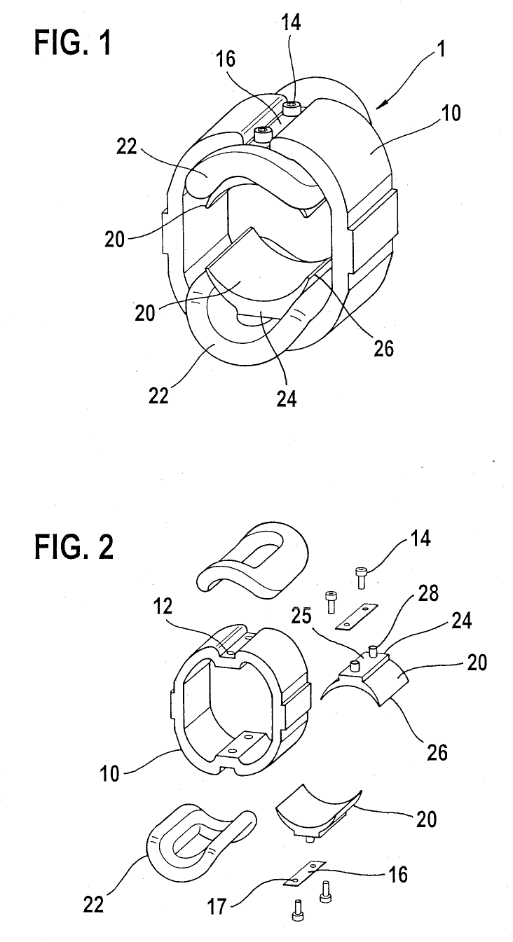

The embodiment of the inventive main element depicted schematically in FIG. 1 is a stator 1 of a two-pole universal motor with an inner-rotor design. Flux return ring 10 of stator 1 is composed—in a manner known per se—of a bundle of lamina that are positioned next to each other axially, end to end (not shown). Stator 10 includes two diametrically opposed poles 20. Poles 20 are positioned over pole shoes 24 on flux return ring 10 and point radially inwardly. Poles 20 with pole shoes 24, which transition into pole horns 26 in the circumferential direction, are designed as one-piece components. A coil 22 is mounted on each one, for field excitation.

According to the present invention, poles 20 are connectable with flux return ring 10. In the embodiment shown, poles 20 are detachably connected with flux return ring 10 using a screw connection. To this end, in the exemplary embodiment shown, two boreholes 12 for each pole 20 are provided in flux return ring 10. Accordingly, poles 20 include two projections 28 with an inner thread (not shown) on surface 25 of pole shoe 24 facing flux return ring 10.

Projections 28 engage from the inside in boreholes 12 in flux return ring 10. The expression “from the inside” means that projections 28 engage in boreholes 12 from the inside of flux return ring 10. A screw 14 is guided, from the outside, through each of the boreholes 12 and engages with the inner thread of projections 28. The expression “from the outside” means that screws 14 are guided through boreholes 12 from the outside of flux return ring 10. In addition, a shim 16 with two boreholes 17 is provided for each pole 20 that bears against the outside of flux return ring 10.

Boreholes 17 in shim 16 align with boreholes 12 of flux return ring 10. Shims 16 enable force to be distributed across a wide area when poles 10 are screwed down, since the pressing force acts not only between the surface of the screw head bearing against flux return ring 10 and the lamina bundle of flux return ring 10, it is also distributed over the entire surface area of shims 16.

It will be understood that each of the elements described above, or two or more together, may also find a useful application in other types of constructions differing from the type described above.

While the invention has been illustrated and described as embodied in a main element for an electrical machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A main element for an electrical machine, comprising a flux return ring with at least two poles that are situated radially on said flux return ring; at least one coil accommodated in each of said two poles, wherein said poles are connected with said flux return ring.

2. A main element as defined in claim 1, wherein the main element is configured as a stator.

3. A main element as defined in claim 1, wherein the main element is configured as a stator for the electrical machine which is a universal motor.

4. A main element as defined in claim 1, wherein said poles are connected with said flux return ring in a form-fit manner.

5. A main element as defined in claim 1, wherein said poles are connected with said flux return ring in a non-positive manner.

6. A main element as defined in claim 1, wherein said poles are connected with said flux return ring in a bonded manner.

7. A main element as defined in claim 1, wherein said poles are detachably connected with said flux return ring.

8. A main element as defined in claim 1, wherein said poles are connected with said flux return ring via a screw connection.

9. A main element as defined in claim 1, wherein said flux return ring is configured as a one-piece component.

10. A main element as defined in claim 1, wherein said flux return ring is configured as lamina bundle.

11. A main element as defined in claim 1, wherein said poles are configured as one-piece components.

12. A main element as defined in claim 1, wherein said poles are composed of iron.

13. A main element as defined in claim 1, wherein said poles are composed of sintered metal.

14. A universal motor, comprising a main element including a flux return ring with at least two poles that are situated radially on said flux return ring, and at least one coil accommodated in each of said two poles, wherein said poles are connected with said flux return ring.
